(19) United States
(12) Patent Application Publication
(10) Pub. No.: US 2008/0243384 A1
(43) Pub. Date: Oct. 2, 2008

(54) AZIMUTH DETERMINATION APPARATUS, AZIMUTH DETERMINATION METHOD AND AZIMUTH DETERMINATION PROGRAM

(75) Inventors: Masashi OHKUBO, Kanagawa (JP); Tomohisa TAKAOKA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/860,013

(22) Filed: Sep. 24, 2007

(30) Foreign Application Priority Data
Oct. 4, 2006 (JP) P2006-273364

(51) Int. Cl. G01C 21/26

(52) U.S. Cl. 701/220; 701/200; 33/354

(57) ABSTRACT

Disclosed herein is an azimuth determination apparatus including: a horizontal-direction acceleration detection section installed in a movable body as a section configured to detect an acceleration caused by a centrifugal force, which is generated when said movable body is making a turn, as an acceleration oriented in a horizontal direction perpendicular to the traveling direction of said movable body. The apparatus further includes an azimuth determination section configured to produce a result of determination as to whether said movable body is making a right or left turn on the basis of said detected acceleration oriented in said horizontal direction and threshold values.

### CROSS REFERENCES TO RELATED APPLICATIONS

The present invention contains subject matter related Japanese Patent Application JP 2006-273364 filed in the Japan Patent Office on Oct. 4, 2006, the entire contents of which being incorporated herein by reference.

### BACKGROUND OF THE INVENTION

1. Field of the Invention

The present invention relates to an azimuth determination apparatus, an azimuth determination method and an azimuth determination program. For example, the present invention is suitably applicable to a car navigation.

2. Description of the Related Art

In the past, there was an angular velocity computation apparatus for computing the angular velocity of a vehicle by merely making use of an acceleration sensor that can be produced at a relatively low cost in place of an expensive angular velocity sensor such as a gyro sensor. For more information, refer to the specification of Japan Patent No. 3416694. In this specification, the specification of Japan Patent No. 3416694 is used as Patent Document 1.

### SUMMARY OF THE INVENTION

By the way, in the angular velocity computation apparatus having a configuration described in Patent Document 1, an angular velocity has to be computed on the basis of the distance between installation positions of two acceleration sensors employed in the angular velocity computation apparatus installed in a vehicle and the velocity of the vehicle.

Addressing the problem described above, the present invention makes an attempt to propose an azimuth determination apparatus capable of finding the azimuth of a movable body and/or the present position of the movable body with a high degree of accuracy by adoption of a simple configuration, propose an azimuth determination method to be adopted in the azimuth determination apparatus and propose an azimuth determination program implementing the azimuth determination method.

### (2) Means for Solving the Problem

In order to solve the problem described above, in accordance with one embodiment of the present invention, a horizontal-direction acceleration detection section installed in a movable body detects an acceleration, which is caused by a centrifugal force of the movable body when the movable body is making a turn as the movement of the movable body to appear as an acceleration oriented in a horizontal direction perpendicular to the direction of a forward movement. Then, the horizontal-direction acceleration detection section produces a result of determination as to whether the movable body is making a turn in the right or left direction on the basis of the detected value of the horizontal-direction acceleration and a threshold value determined in advance. In this way, the present invention is capable of producing a result of determination as to whether the movable body is rotating in the right or left direction with a high degree of accuracy by adoption of a simple configuration including only a single horizontal-direction acceleration detection section without making use of an angular-velocity detection section.

In accordance with the present invention, computation processes are carried out to detect a traveling velocity in the traveling direction of a movable body, compute an angular velocity of a turn made by the movable body on the basis of a horizontal-direction acceleration and the traveling velocity and find a relative positional change on the basis of the traveling velocity and the angular velocity in order to update the present position of the movable body. In this way, the present invention is capable of computing the present position of the movable body with a high degree of accuracy by adoption of a simple configuration including only a single horizontal-direction acceleration detection section without making use of an angular-velocity detection section.

As described above, in accordance with the present invention, it is possible to realize an azimuth determination apparatus capable of finding the azimuth of a movable body and/or the present position of the movable body with a high degree of accuracy by adoption of a simple configuration including only a single horizontal-direction acceleration detection section without making use of an angular-velocity detection section, realize an azimuth determination method to be adopted by the azimuth determination apparatus and implement an azimuth determination program implementing the azimuth determination method.

### BRIEF DESCRIPTION OF THE DRAWINGS

These and other features of the present invention will become clear from the following description of the preferred embodiments given with reference to the accompanying diagrams, in which:

FIG. 1 is diagram showing a characteristic curve to be referred to in explanation of a technique to produce a result of determination as to whether a turn made by a vehicle is a right or left turn by making use of a transversal G value;

FIG. 2 is diagram to be referred to in explanation of a gravitational acceleration component generated when a vehicle is running on the surface of an inclined road;

FIG. 3 is diagram showing a characteristic curve representing an output waveform shifted by an offset corresponding to a gravitational acceleration component as the output waveform of the transversal G value;

FIG. 4 is diagram to be referred to in explanation of a technique to estimate a present position on the basis of a relative positional change;

FIG. 5 is a block diagram roughly showing the configuration of a car navigation apparatus according to an embodiment;

FIG. 6 shows a flowchart representing the procedure of processing to determine an azimuth without making use of an angular-velocity sensor;

FIG. 7 shows a flowchart representing the procedure of processing to estimate a present position without making use of an angular-velocity sensor;

FIG. 8 is a block diagram roughly showing a first configuration of a car navigation apparatus according to another embodiment; and

FIG. 9 is a block diagram roughly showing a second configuration of a car navigation apparatus according to another embodiment.

### DETAILED DESCRIPTION OF THE PREFERRED EMBODIMENTS

Embodiments of the present invention are described in detail by referring to diagrams as follows.

### (1) Basic Principle of the Invention

The basic principle of the invention is explained as follows. In a car navigation apparatus provided by the present invention as a car navigation apparatus mounted on a vehicle, a 2-axis acceleration sensor is capable of detecting a traveling-direction acceleration oriented in the traveling direction of the vehicle and a transversal acceleration in a horizontal direction perpendicular to the traveling direction. In the following description, the transversal acceleration is referred to as transversal G. The 2-axis acceleration sensor is used for detecting transversal G (that is, a transversal acceleration) generated in a turn made by the vehicle. A detected value of transversal G is used as a reference to determine the azimuth of the vehicle. In the following description, the detected value of transversal G is referred to as a transversal G value. On the basis of the traveling velocity in the traveling direction of the vehicle and the transversal G value, the angular velocity of the turn made by the vehicle is computed. Then, on the basis of the traveling velocity and angular velocity, a relative positional change is found in order to estimate the present position of the vehicle.

### (1-1) Azimuth Determination Principle

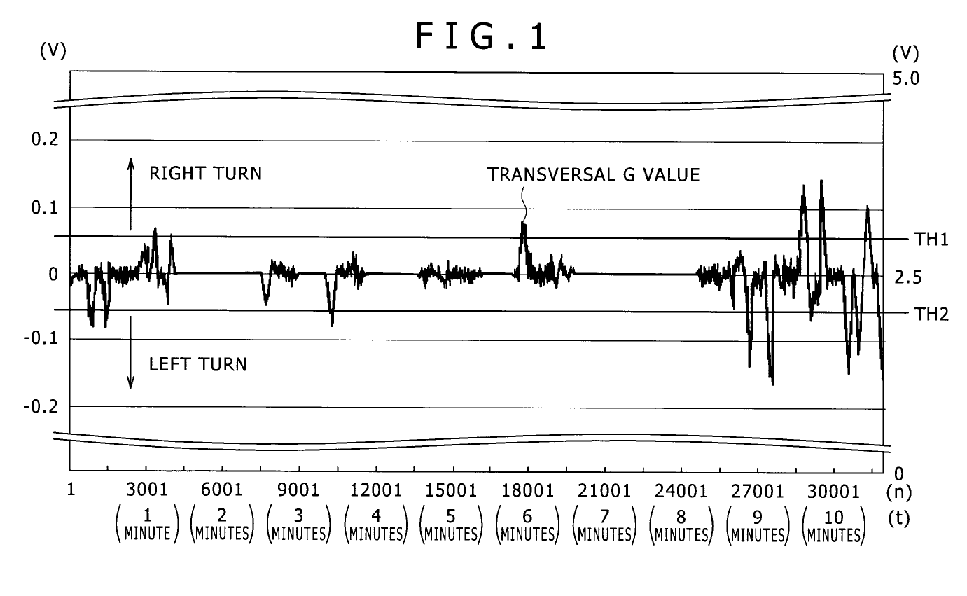

FIG. 1 is a diagram illustrating a transversal G graph showing a voltage output by a 2-axis acceleration sensor as a voltage representing the transversal G value detected by the sensor at a sampling frequency (n) of 50 times per second. To be more specific, the transversal G graph shows how the transversal G value represented by the vertical axis changes with the lapse of time (t) represented by the horizontal axis.

The horizontal axis can also represent a sampling count (n) in place of the lapsing time (t), which is expressed in terms of minutes. In the case of the transversal G graph shown in FIG. 1, the horizontal axis represents both the sampling count (n) and the lapsing time (t).

The voltage represented by the horizontal axis to represent the voltage output by the 2-axis acceleration sensor changes over the range 0 V to 5 V. In a state in which transversal G is not generated at all as a transversal acceleration of the vehicle, the electric potential of the voltage output by the 2-axis acceleration sensor is 2.5 V shown on the vertical axis on the right side. If the voltage output by the 2-axis acceleration sensor is supplied to a high-pass filter in order to remove the direct-current component of the voltage, the voltage output by the filter can be represented by the vertical axis on the left side. On the vertical axis on the left side, the electric potential of the voltage output by the 2-axis acceleration sensor in a state in which transversal G is not generated at all as a transversal acceleration of the vehicle is 0 V.

The transversal G graph shown in FIG. 1 actually represents the waveform of a voltage output by a low-pass filter serving as a filter for eliminating harmonic components from the voltage output by the 2-axis acceleration sensor as a voltage representing the transversal G value.

The output waveform of the transversal G value is drawn by taking a centrifugal force, which is applied to the left side of the vehicle in the horizontal direction when the vehicle makes a right turn, as a positive value and taking a centrifugal force, which is applied to the right side of the vehicle in the horizontal direction when the vehicle makes a left turn, as a negative value. The amplitude of the output waveform of the transversal G value varies proportionally to the magnitude of the centrifugal force.

Thus, a navigation apparatus installed in a vehicle is capable of recognizing the azimuth of the vehicle by determining that the vehicle is making a right turn at a time (t) if the difference between the level of the voltage representing the transversal G value output at the time (t) and the O-[V] reference output exceeds a predetermined threshold value TH1 set in advance or a left turn at a time (t) if the same difference exceeds a predetermined threshold value TH2 also set in advance.

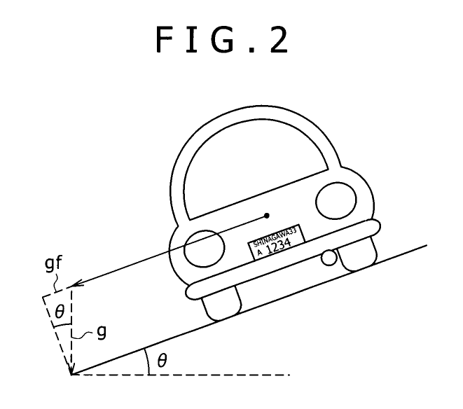

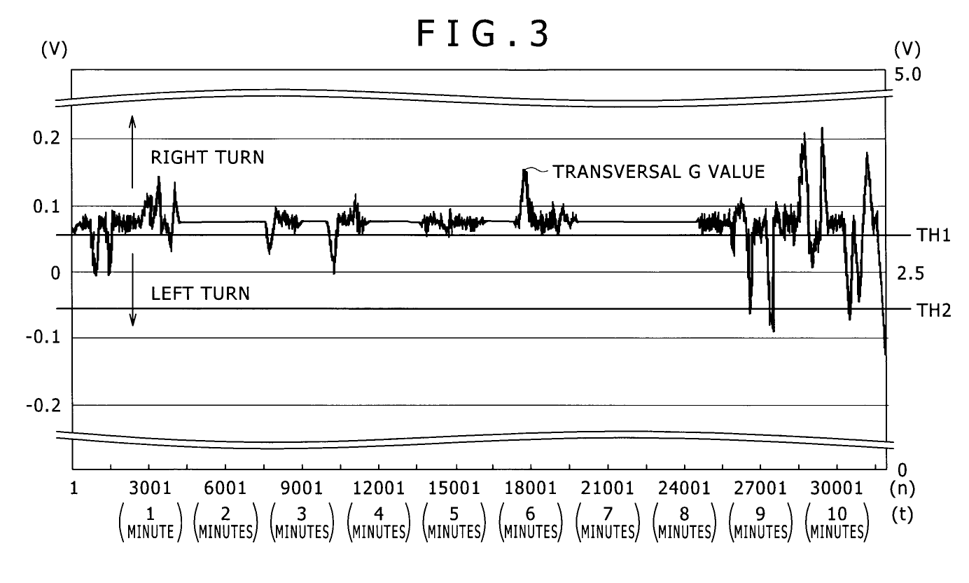

By the way, when a vehicle is running on the surface of a road inclined by an angle θ as shown in FIG. 2, the transversal G value output by the 2-axis acceleration sensor includes a gravitational acceleration component gf. In this case, the output waveform of the transversal G value appears as a waveform shifted by an offset corresponding to the electric potential of the gravitational acceleration component gf as shown in FIG. 3. This offset causes an error in the result of comparing the difference described above with the threshold value TH1 or TH2.

In the case of a car navigation apparatus provided by the present invention, however, the voltage output by the 2-axis acceleration sensor is supplied to a high-pass filter in order to remove the direct-current component of the voltage and the electric potential of the voltage output by the 2-axis acceleration sensor with transversal G not generated at all as a transversal acceleration of the vehicle is taken as a reference output of 0 V so as to obtain an output waveform of the transversal G value in a state of excluding the offset of the gravitational acceleration component gf in advance. Thus, it is possible to prevent an incorrect determination result from being obtained by comparing the difference described above with the threshold value TH1 or TH2.

### (1-2) Principle of Estimating the Present Position

In addition, since the car navigation apparatus mounted on a vehicle finds the angular velocity ω in right and left turns without making use of an angular-velocity sensor, by considering that the angular velocity ω is a function of transversal G value α and also a function of traveling velocity v, the angular velocity ω can be found with a high degree of accuracy by making use of the following equation:

ω=α/v (1)

The transversal G value α cited above is an acceleration caused by the centrifugal force whereas the traveling velocity v can be found as the traveling velocity of the vehicle typically on the basis of car-velocity pulses generated by the vehicle.

By the way, the traveling velocity v of the vehicle can be found not necessarily on the basis of car-velocity pulses generated by the vehicle. For example, as an alternative, the traveling velocity v of the vehicle can be found on the basis of a satellite signal received by a GPS (Global Positioning System) receiver from a GPS satellite. As another alternative, the traveling velocity v of the vehicle can be found by integration of the traveling-direction acceleration output by the 2-axis acceleration sensor. That is to say, the traveling velocity v of the vehicle can be found by adoption of a variety of techniques other than the method based on car-velocity pulses generated by the vehicle.

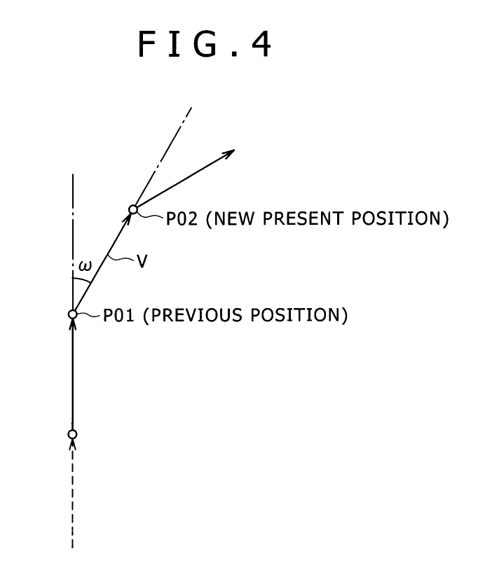

On the basis of the angular velocity ω found by making use of Eq. (1) and the traveling velocity v oriented in the traveling direction of the vehicle, the car navigation apparatus finds a relative positional change from a previous position PO1 to the next new position PO2 and adds the relative positional change to the previous position PO1 in order to find the next new position PO2 as shown in FIG. 4.

The relative positional change shows a vehicle azimuth change caused by the angular velocity ω as well as a vehicle movement distance caused by the traveling velocity v. That is to say, the relative positional change or a relative change in position represents a relative positional change used to find the next new position PO2 from the previous position PO1.

Thus, the car navigation apparatus is capable of easily finding the angular velocity ω on the basis of the transversal G value α output by the 2-axis acceleration sensor and the traveling velocity v of the vehicle by making use of no angular-velocity sensor with a high degree of accuracy. In this way, the car navigation apparatus is capable of implementing an autonomous navigation method by making use of the angular velocity ω.

### (2) Configuration of the Car Navigation Apparatus

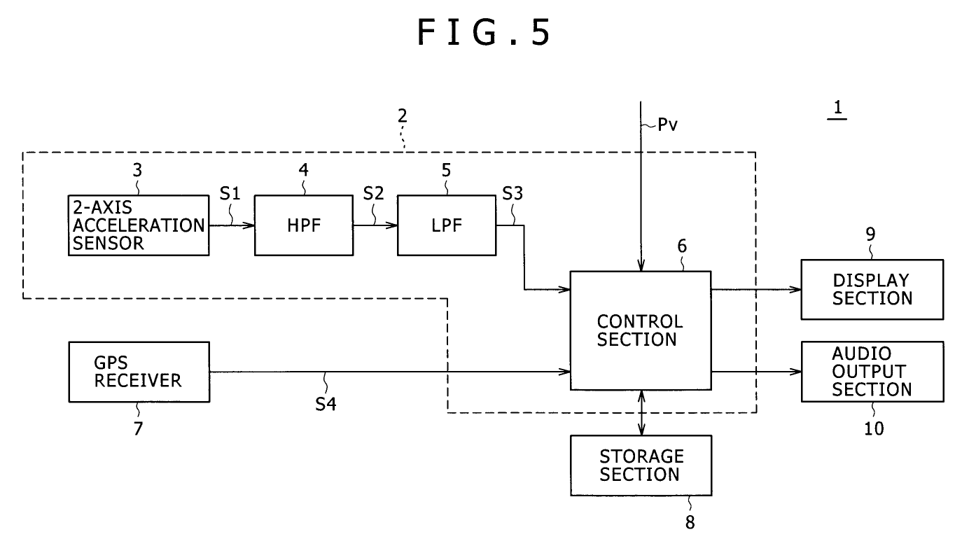

By referring to FIG. 5, the following description explains the concrete configuration of the car navigation apparatus mounted on a vehicle for providing route guidance to the driver of the vehicle by adoption of the basic principle described above as the basic principle of the present invention.

In FIG. 5, reference numeral 1 denotes an entire car navigation apparatus according to an embodiment of the present invention. The car navigation apparatus 1 mounted on a vehicle is characterized in that the car navigation apparatus 1 employs an azimuth determination section 2 for determining the azimuth of the vehicle on the basis of the azimuth determination principle without making use of an angular-velocity sensor and for estimating the present position of the vehicle on the basis of the present-position estimation principle without making use of an angular-velocity sensor by finding the angular velocity ω.

A control section 6 employed in the azimuth determination section 2 has a configuration based on a CPU (Central Processing Unit). The control section 6 manages and controls the whole car navigation apparatus 1 by execution of a basic program read out from a storage section 8, which is typically a hard disk. In addition, the control section 6 also carries out a procedure to be described later as the procedure of processing to determine an azimuth without making use of an angular-velocity sensor and a procedure to be described later as the procedure of processing to estimate a present position also without making use of an angular-velocity sensor by execution of application programs such as an azimuth determination program read out from the storage section 8.

In actuality, a GPS receiver 7 employed in the car navigation apparatus 1 receives satellite information S4 from a GPS satellite and passes on the satellite information S4 to the control section 6. On the basis of the satellite information S4, the control section 6 is capable of computing quantities such as the present position PO of the vehicle and the traveling velocity v of the vehicle. On the basis of the computed quantities, the present position PO is displayed on a display section 9, which is typically a liquid crystal display section, and a voice mentioning information such routes leading to the destination is output to a speaker or the like by way of an audio output section 10. In this way, a navigation operation is carried out in order to give a route guide to the driver of the vehicle and display the present position.

### (2-1) Azimuth Determination Technique Using No Angular-Velocity Sensor

Thus, when the GPS receiver 7 employed in the car navigation apparatus 1 is capable of receiving the satellite information S4, there is no problem. When the vehicle is running through a tunnel or along a street between buildings, that is, when the vehicle is running in an environment where reception of the satellite information S4 is disabled, however, there is a problem. Nevertheless, a route guide is required continuously even if the vehicle is put in such an environment.

In such a case, a 2-axis acceleration sensor 3 employed in the azimuth determination section 2 of the car navigation apparatus 1 detects a transversal G value S1 oriented in a horizontal direction perpendicular to the traveling direction of the vehicle and passes on the transversal G value S1 to a high-pass filter 4.

The high-pass filter 4 eliminates the direct-current component from the transversal G value S1 so as to set the electric potential of the voltage output by the 2-axis acceleration sensor 3 with transversal G not generated at all as a transversal acceleration of the vehicle at a reference output of 0 V. Data S2 output by the high-pass filter 4 is supplied to a low-pass filter 5.

The low-pass filter 5 removes harmonic components from the data S2 output by the high-pass filter 4 in order to generate an output transversal G value S3 having a smooth waveform and supplies the output transversal G value S3 to the control section 6. The waveform of the output transversal G value S3 corresponds to the transversal G graph shown in FIG. 1.

By comparing the voltage level of the output transversal G value S3 with threshold values TH1 and TH2, the control section 6 produces a result of determination as to whether the vehicle is making a right or left turn and, on the basis of the result of the determination, the control section 6 displays an icon on the display section 9 as an icon representing an azimuth at the present position of the vehicle and outputs a voice mentioning the azimuth to the audio output section 10 in order provide route guidance to the driver.

### (2-2) Azimuth Determination Processing Procedure Using No Angular-Velocity Sensor

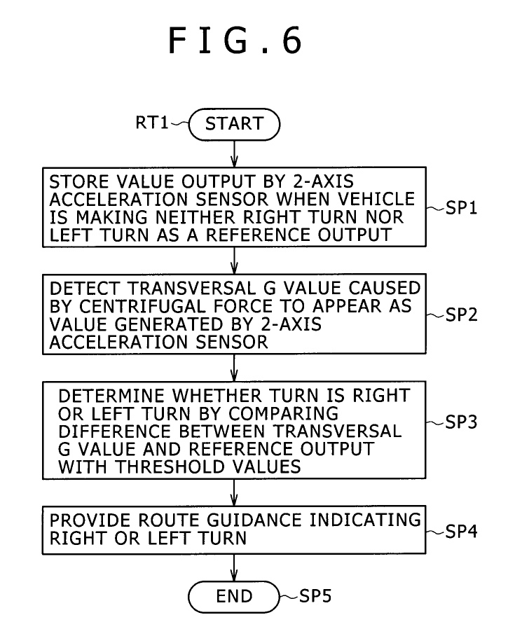

To put it concretely, the control section 6 employed in the azimuth determination section 2 starts the procedure of processing to determine an azimuth of the vehicle by making use of no angular velocity sensor from a beginning step of a flowchart shown in FIG. 6 to represent a routine RT1 of the procedure. The flow of the routine RT1 then goes on to a step SP1. At this step, the control section 6 stores the output transversal G value S3 supplied by the 2-axis acceleration sensor 3 to the control section 6 initially in a RAM as a reference output. The output transversal G value S3, which is supplied to the control section 6 initially when the vehicle is making neither right turn nor left turn, is an output voltage of 0 V. The output voltage is supplied to the control section 6 from the 2-axis acceleration sensor 3 by way of the high-pass filter 4 and the low-pass filter 5. Then, the flow of the routine RT1 goes on to the next step SP2.

At the step SP2, when the vehicle is making a turn, the control section 6 detects a transversal G value S3 caused by a centrifugal force as an acceleration generated by the 2-axis acceleration sensor 3 in the horizontal direction perpendicular to the traveling direction of the vehicle and supplied to the control section 6 as the transversal G value S3 by way of the high-pass filter 4 and the low-pass filter 5. Then, the flow of the routine RT1 goes on to the next step SP3.

At the step SP3, the control section 6 computes a difference between the transversal G value S3 received in the process carried out at the step SP2 as the transversal G value S3 generated when the vehicle is making a turn and the reference output held in the process carried out at the step S2. Then, the control section 6 compares the difference found in the process carried out at the step SP1 with the threshold values TH1 and TH2. If the difference is found greater than the threshold value TH1, the control section 6 determines that the vehicle is making a right turn. If the difference is found greater than the threshold value TH2, on the other hand, the control section 6 determines that the vehicle is making a left turn. Then, the flow of the routine RT1 goes on to the next step SP4.

At the step SP4, the control section 6 displays an icon on the display section 9 as an icon representing an azimuth determined in the process carried out at the step SP3 as a present-position azimuth of the vehicle and outputs a voice mentioning the azimuth to the audio output section 10 in order provide route guidance to the driver. Then, the flow of the routine RT1 goes on to the next step SP5 at which the execution of the routine RT1 is ended.

### (2-3) Present-Position Estimation Technique Using No Angular-Velocity Sensor

As described earlier, the 2-axis acceleration sensor 3 employed in the azimuth determination section 2 of the car navigation apparatus 1 detects a transversal G value S1 oriented in a horizontal direction perpendicular to the traveling direction of the vehicle and passes on the transversal G value S1 to the high-pass filter 4.

The high-pass filter 4 eliminates the direct-current component from the transversal G value S1 so as to set the electric potential of the voltage output by the 2-axis acceleration sensor 3 with transversal G not generated at all as a transversal acceleration of the vehicle at a reference output of 0 V. Data S2 output by the high-pass filter 4 is supplied to a low-pass filter 5.

The low-pass filter 5 removes harmonic components from the data S2 output by the high-pass filter 4 in order to generate an output transversal G value S3 having a smooth waveform and supplies the output transversal G value S3 to the control section 6.

On the basis of car-velocity pulses Pv generated by the vehicle, the control section 6 computes a traveling velocity v oriented in the traveling direction of the vehicle. Then, the control section 6 divides the output transversal G value S3 received from the low-pass filter 5 by the traveling velocity v in order to yield an angular velocity ω during the turn made by the vehicle as indicated by Eq. (1).

Subsequently, on the basis of the traveling velocity v and the angular velocity w, the control section 6 finds a relative positional change from the previous position PO1 to the next new position PO2 as shown in FIG. 4. Then, the control section 6 adds the relative positional change to the previous position PO1 in order to find (or estimate) the next new position PO2. On the basis of the estimated result, the autonomous navigation method is implemented.

### (2-4) Present-Position Estimation Processing Procedure Using No Angular-Velocity Sensor

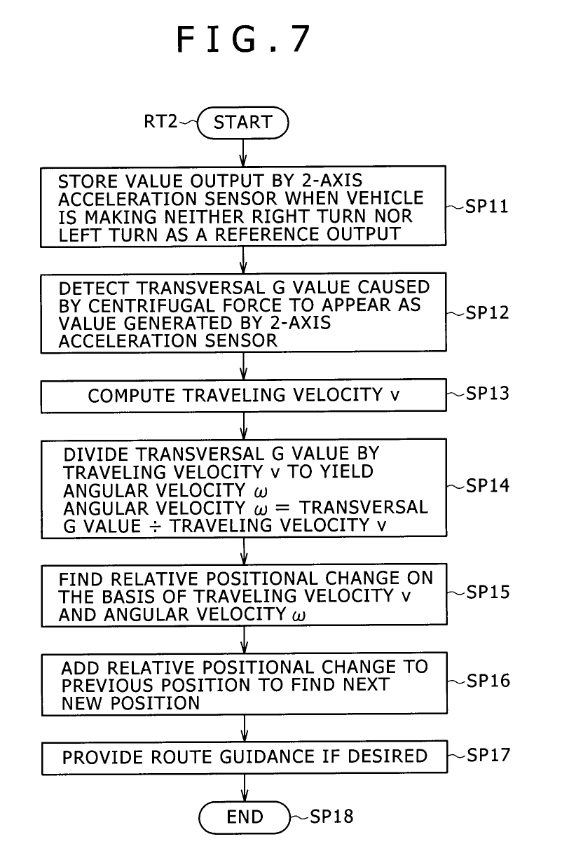

To put it concretely, the control section 6 employed in the azimuth determination section 2 starts the procedure of processing to estimate the present position of the vehicle by making use of no angular velocity sensor from a beginning step of a flowchart shown in FIG. 7 to represent a routine RT2 of the procedure. The flow of the routine RT2 then goes on to a step SP11. At this step, the control section 6 stores the output transversal G value S3 supplied to the control section 6 initially in a RAM as a reference output. The output transversal G value S3, which is supplied to the control section 6 initially when the vehicle is making neither right turn nor left turn, is an output voltage of V. The output voltage is supplied to the control section 6 from the 2-axis acceleration sensor 3 by way of the high-pass filter 4 and the low-pass filter 5. Then, the flow of the routine RT2 goes on to the next step SP12.

At the step SP12, when the vehicle is making a turn, the control section 6 detects a transversal G value S3 representing a centrifugal force generated by the 2-axis acceleration sensor 3 and supplied to the control section 6 as the transversal G value S3 by way of the high-pass filter 4 and the low-pass filter 5. Then, the flow of the routine RT2 goes on to the next step SP13.

At the step SP13, on the basis of car-velocity pulses Pv generated by the vehicle, the control section 6 computes a traveling velocity v oriented in the traveling direction of the vehicle. Then, the flow of the routine RT2 goes on to the next step SP14.

At the step SP14, the control section 6 divides the output transversal G value S3 received from the low-pass filter 5 by the traveling velocity v in order to yield an angular velocity ω during a turn made by the vehicle as indicated by Eq. (1). Then, the flow of the routine RT2 goes on to the next step SP15.

At the step SP15, on the basis of the traveling velocity v computed in the process carried out at the step SP13 and the angular velocity ω computed in the process carried out at the step SP14, the control section 6 finds a relative positional change from the previous position PO1 to the next new position PO2 as shown in FIG. 4. Then, the flow of the routine RT2 goes on to the next step SP16.

At the step SP16, the control section 6 adds the relative positional change computed in the process carried out at the step SP15 to the previous position PO1 in order to find (or estimate) the next new position PO2. Then, the flow of the routine RT2 goes on to the next step SP17.

At the step SP17, the control section 6 displays an icon on the display section 9 as an icon representing the next new position PO2 estimated in the process carried out at the step SP16 as the present position of the vehicle and outputs a voice mentioning the next new position PO2 to the audio output section 10 in order provide route guidance to the driver. Then, the flow of the routine RT1 goes on to the next step SP18 at which the execution of the routine RT2 is ended.

### (3) Operations and Effects

In the configuration described above, the car navigation apparatus 1 is capable of easily determining an azimuth and estimating the present position with ease by making use of only the output of the 2-axis acceleration sensor 3 employed in the azimuth determination section 2 and without making use of an angular-velocity sensor. That is to say, the car navigation apparatus 1 is capable of carrying out its functions with the single 2-axis acceleration sensor 3 with typical dimensions of approximately 4 [m]×4 [m]×1.5 [m], which are smaller than typical dimensions of approximately 10 [m]×10 [m]×3 [m] for the angular-velocity sensor. Thus, the present invention much contributes to the size reduction of the car navigation apparatus as well as the weight reduction of the apparatus.

In addition, the car navigation apparatus 1 has a configuration employing the single 2-axis acceleration sensor 3 and is yet capable of computing an angular velocity ω by adoption of a simple computation method based on Eq. (1). Thus, in comparison with the existing angular-velocity computation method described in Patent Document 1, the car navigation apparatus 1 has a simple configuration and an extremely small processing load borne in the processing to compute an angular velocity ω.

In addition, in the car navigation apparatus 1, the high-pass filter 4 eliminates the direct-current component from the transversal G value S1 so as to set the electric potential of the voltage output by the 2-axis acceleration sensor 3 with transversal G not generated at all as a transversal acceleration of the vehicle at a reference output of 0 V. It is thus possible to obtain an output waveform of the transversal G value in a state of excluding the offset of the gravitational acceleration component gf in advance even when the vehicle is running on the surface of a road inclined by an angle θ as shown in FIG. 2 to result in such an offset. In addition, the car navigation apparatus 1 is capable of determining an azimuth and estimating a present position with a high degree of accuracy.

The configuration described so far as the configuration of the car navigation apparatus 1 is a simple configuration employing single 2-axis acceleration sensor 3 and, yet, the car navigation apparatus 1 is capable of determining an azimuth and estimating a present position with a high degree of accuracy.

### (4) Other Embodiments

The embodiment described so far employs a 2-axis acceleration sensor 3 capable of detecting an acceleration in the traveling direction and transversal G. It is to be noted, however, that the scope of the present invention is by no means limited to such a feature of the embodiment. That is to say, it is possible to employ a 1-axis acceleration sensor capable of detecting only transversal G or a 3-axis acceleration sensor capable of detecting an acceleration in the traveling direction, transversal G and an acceleration in the gravitational direction.

In addition, in the embodiment described so far, on the basis of car-velocity pulses Pv generated by the vehicle, the control section 6 computes a traveling velocity v oriented in the traveling direction of the vehicle. It is to be noted, however, that the scope of the present invention is by no means limited to such a feature of the embodiment. For example, the control section 6 may compute a traveling velocity v oriented in the traveling direction of the vehicle on the basis of satellite information S4 received from a GPS satellite. As an alternative, the control section 6 may compute a traveling velocity v oriented in the traveling direction of the vehicle on the basis of an acceleration detected by the 2-axis acceleration sensor 3 as an acceleration in the traveling direction.

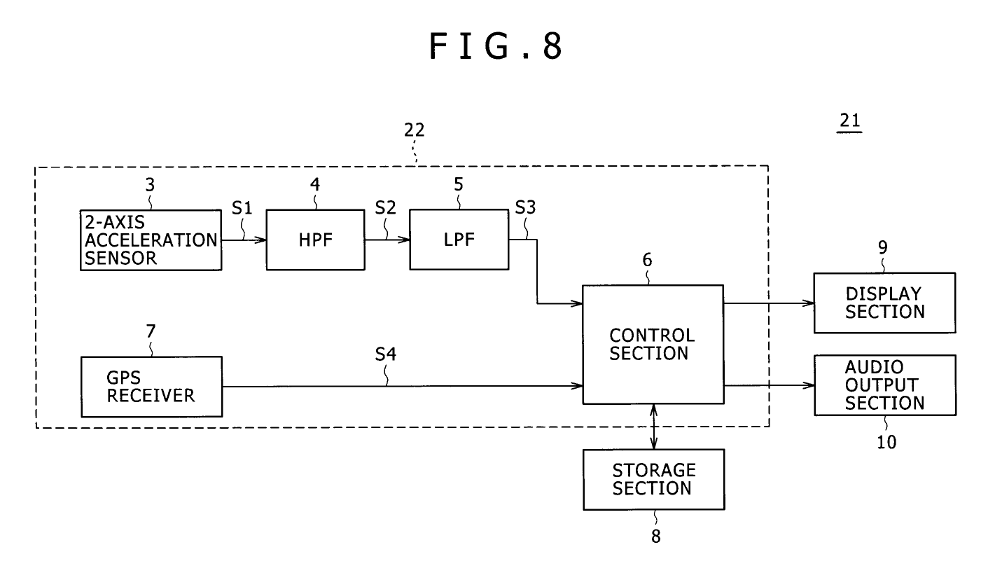

If the control section 6 is to compute a traveling velocity v oriented in the traveling direction of the vehicle on the basis of satellite information S4 received from a GPS satellite through the GPS receiver 7, the configuration of the car navigation apparatus 1 can be restructured into one shown in FIG. 8 to obtain a car navigation apparatus 21. Sections employed in the configuration shown in FIG. 8 as sections identical with their respective counterparts employed in the configuration shown in FIG. 5 are denoted by the same reference numerals as the counterparts. The car navigation apparatus 21 having the configuration shown in FIG. 8 employs an azimuth determination section 22 including a 2-axis acceleration sensor 3, a high-pass filter 4, a low-pass filter 5, a control section 6 and a GPS receiver 7.

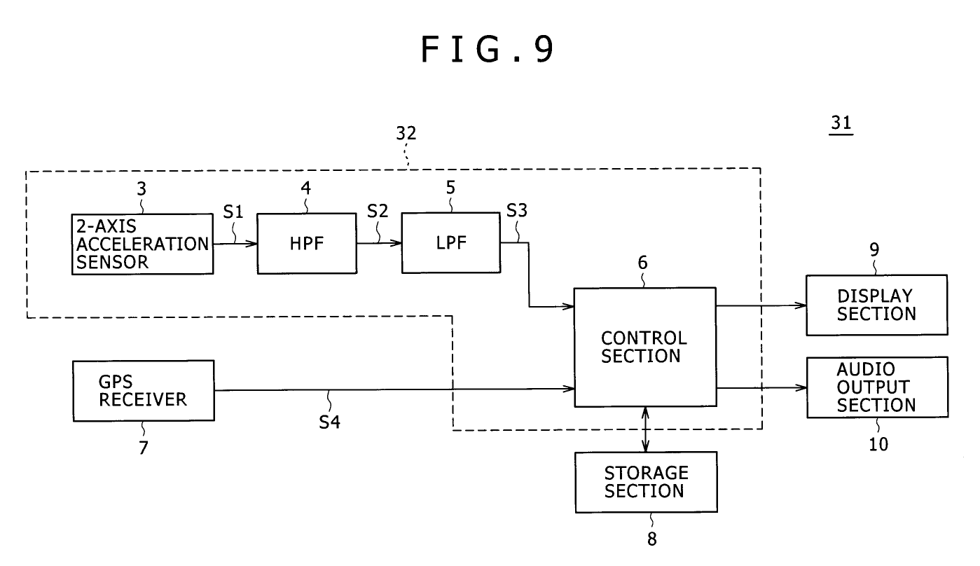

If the control section 6 is to compute a traveling velocity v oriented in the traveling direction of the vehicle on the basis of an acceleration detected by the 2-axis acceleration sensor 3 as an acceleration in the traveling direction, the configuration of the car navigation apparatus 1 can be restructured into one shown in FIG. 9 to obtain a car navigation apparatus 31. Sections employed in the configuration shown in FIG. 9 as sections identical with their respective counterparts employed in the configuration shown in FIG. 5 are denoted by the same reference numerals as the counterparts. The car navigation apparatus 31 having the configuration shown in FIG. 9 employs an azimuth determination section 32 including a 2-axis acceleration sensor 3, a high-pass filter 4, a low-pass filter 5, and a control section 6. In the case of the car navigation apparatus 31 shown in FIG. 9, however, the 2-axis acceleration sensor 3 also generates an acceleration in the traveling direction and supplies the acceleration in the traveling direction to the control section 6 by way of the high-pass filter 4 and the low-pass filter 5.

In addition, in the embodiment described above, the control section 6 loads application programs such as an azimuth determination program and a present-position estimation program from the storage section 8 into a RAM and executes the programs stored in the RAM in order to carry out respectively the routine RT1 representing the procedure of processing to determine the azimuth of the vehicle without making use of an angular-velocity sensor and the routine RT2 representing the procedure of processing to estimate the present position of the vehicle without making use of an angular-velocity sensor. It is to be noted, however, that the scope of the present invention is by no means limited to such a feature of the embodiment. For example, instead of storing the application programs in the storage section 8 in advance, the control section 6 may also carry out the routine RT1 representing the procedure of processing to determine the azimuth of the vehicle without making use of an angular-velocity sensor and the routine RT2 representing the procedure of processing to estimate the present position of the vehicle without making use of an angular-velocity sensor by execution of respectively an azimuth determination program and a present-position estimation program, which are installed from a recording medium into the storage section 8 or downloaded from the Internet into the storage section 8.

In addition, in the embodiment described above, a vehicle is taken as a movable body. It is to be noted, however, that the scope of the present invention is by no means limited to such an application. For example, the movable body can be any other moving object such as a motorcycle, a ship or a bicycle.

In addition, in the embodiment described above, the high-pass filter 4 and the low-pass filter 5 are each a hardware component. It is to be noted, however, that the scope of the present invention is by no means limited to such an implementation. For example, the control section 6 may also execute software in order to carry out the functions of the high-pass filter 4 and the low-pass filter 5.

In addition, the car navigation apparatus 1 according to the embodiment described above as an embodiment of the present invention employs the azimuth determination section 2 to serve as an azimuth determination apparatus including the 2-axis acceleration sensor 3 to serve as a horizontal-direction acceleration detection unit and the control section 6 to serve as an azimuth determination unit. It is to be noted, however, that the scope of the present invention is by no means limited to such a configuration. That is to say, the navigation apparatus can have one of a variety of configurations. For example, the navigation apparatus may also employ a 3-axis acceleration sensor to serve as a horizontal-direction acceleration detection unit and a microcomputer to serve as an azimuth determination unit.

In addition, it should be understood by those skilled in the art that a variety of modifications, combinations, sub-combinations and alterations may occur in dependence on design requirements and other factors insofar as they are within the scope of the appended claims or the equivalents thereof.

The azimuth determination apparatus, the azimuth determination method and the azimuth determination program, which are provided by the present invention, can be applied to not only a navigation apparatus, but also a variety of other electronic apparatus such as an autonomous car radio controller and the controller of a game machine.

What is claimed is:

1. An azimuth determination apparatus comprising:
horizontal-direction acceleration detection means installed in a movable body as means for detecting an acceleration caused by a centrifugal force, which is generated when said movable body is making a turn, as an acceleration oriented in a horizontal direction perpendicular to the traveling direction of said movable body; and
azimuth determination means for producing a result of determination as to whether said movable body is making a right or left turn on the basis of said detected acceleration oriented in said horizontal direction and threshold values.

2. The azimuth determination apparatus according to claim 1, said azimuth determination apparatus further comprising
guidance means for providing route guidance regarding the direction of said movable body by making use of said determination result produced by said azimuth determination means.

3. The azimuth determination apparatus according to claim 1, said azimuth determination apparatus further comprising:
traveling-velocity detection means for detecting a traveling velocity oriented in the traveling direction of said movable body as the traveling velocity of said movable body;
angular-velocity computation means for computing an angular velocity in a turn made by said movable body on the basis of said acceleration oriented in said horizontal direction and said traveling velocity oriented in said traveling direction; and
position updating means for finding a relative positional change on the basis of said traveling velocity as well as said angular velocity and use said relative positional change in order to update the present position of said movable body.

4. The azimuth determination apparatus according to claim 3, said azimuth determination apparatus further comprising
guidance means for providing route guidance regarding the direction of said movable body by making use of said present position of said movable body.

5. An azimuth determination method provided for a movable body, said azimuth determination method comprising the steps of:
driving horizontal-direction acceleration detection means installed in said movable body to detect an acceleration caused by a centrifugal force, which is generated when said movable body is making a turn, as an acceleration oriented in a horizontal direction perpendicular to the traveling direction of said movable body; and
producing a result of determination as to whether said movable body is making a right or left turn on the basis of said detected acceleration oriented in said horizontal direction and threshold values.

6. The azimuth determination method according to claim 5, said azimuth determination method further comprising the step of
providing guidance regarding the direction of said movable body by making use of said determination result produced in said step of producing a result of determination as to whether said movable body is making a right or left turn.

7. The azimuth determination method according to claim 5, said azimuth determination method further comprising the steps of:
detecting a traveling velocity oriented in the traveling direction of said movable body as the traveling velocity of said movable body;
computing an angular velocity in a turn made by said movable body on the basis of said acceleration oriented in said horizontal direction and said traveling velocity oriented in said traveling direction; and
finding a relative positional change on the basis of said traveling velocity as well as said angular velocity and using said relative positional change in order to update the present position of said movable body.

8. The azimuth determination method according to claim 7, said azimuth determination method further comprising the step of
providing guidance regarding the direction of said movable body by making use of said present position updated at said step to update the present position of said movable body.

9. An azimuth determination apparatus comprising:
a horizontal-direction acceleration detection section installed in a movable body as a section configured to detect an acceleration caused by a centrifugal force, which is generated when said movable body is making a turn, as an acceleration oriented in a horizontal direction perpendicular to the traveling direction of said movable body; and
an azimuth determination section configured to produce a result of determination as to whether said movable body is making a right or left turn on the basis of said detected acceleration oriented in said horizontal direction and threshold values.
